(19) United States
(12) Patent Application Publication
(10) Pub. No.: US 2014/0261014 A1
(43) Pub. Date: Sep. 18, 2014

(54) Barbecue Apparatus

(71) Applicant: Kiosky Chung, Taichung City (TW)

(72) Inventor: Kiosky Chung, Taichung City (TW)

(21) Appl. No.: 13/836,246

(22) Filed: Mar. 15, 2013

(51) Int. Cl. A47J 37/06

(52) U.S. Cl. CPC A47J 37/0694
USPC 99/450

(57) ABSTRACT

A grill assembly including a grill and at least one handle. The handle includes a grip and a connector. The connector includes a first plate connected to the grill, a second plate connected to the grip, and a saddle adapted for placement on an edge of a bowl of a barbecue apparatus. The saddle includes a top and first and second panels respectively extending to the first and second plate from the top. The second plate extends below an edge of a cover laid on the bowl when the top is placed on the edge of the bowl.

### BACKGROUND OF INVENTION

1. Field of Invention

The present invention relates to a barbecue apparatus and, more particularly, to a safe and reliable barbecue apparatus.

2. Related Prior Art

In a barbecue party, people enjoy cooperating with one another to cook food and enjoy the cooked food. A barbecue party that often takes place in an outdoor environment is more relaxing than a feast that often takes place in a restaurant. Hence, barbecue parties are very popular in close friends and families. Therefore have been devised many barbecue grill apparatuses.

A barbecue grill is made of metal bars. Without a handle, it is difficult to maneuver the barbecue grill.

A handle that is made of metal may be secured to the barbecue grill by welding. However, heat is easily transferred to the handle from the barbecue grill. It is dangerous to hold the handle to maneuver the barbecue grill.

A handle that is made of metal may be detachably attached to the barbecue grill. However, the handle could easily be lost.

Therefore, the present invention is intended to obviate or at least alleviate the problems encountered in prior art.

### SUMMARY OF INVENTION

It is the primary objective of the present invention to provide a barbecue apparatus with a safe and reliable grill assembly.

To achieve the foregoing objective, the grill assembly includes a grill and at least one handle. The handle includes a grip and a connector. The connector includes a first plate connected to the grill, a second plate connected to the grip, and a saddle adapted for placement on an edge of a bowl of a barbecue apparatus. The saddle includes a top and first and second panels respectively extending to the first and second plate from the top. The second plate extends below an edge of a cover laid on the bowl when the top is placed on the edge of the bowl.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a barbecue apparatus according to the preferred embodiment of the present invention;

FIG. 2 is a perspective view of a grill assembly of the barbecue apparatus shown in FIG. 1;

FIG. 3 is an exploded view of the grill assembly of FIG. 2; and

FIG. 4 is a cross-sectional view of the barbecue apparatus shown in FIG. 1.

### DETAILED DESCRIPTION OF PREFERRED EMBODIMENT

Referring to FIG. 1, a safe and reliable barbecue apparatus includes a stove 10 and a grill assembly according to the preferred embodiment of the present invention. The stove 10 includes a bowl 12, a cover 14 pivotally connected to the bowl 12 by two hinges, and a handle 16 secured to the cover 14. The bowl 12 includes an edge.

Referring to FIGS. 2 and 3, the grill assembly includes a grill 20 and two handles 30. The grill 20 includes a frame 22, longitudinal bars 24 and crossbars 26. The frame 22 is made of a substantially rectangular configuration. The frame 22 includes two longitudinal members extending between two transverse members. Each of the longitudinal members is formed with a flat portion 21. The longitudinal bars 24, which extend parallel to one another, are secured to the transverse members of the frame 22 by welding for example. The crossbars 26, which extend parallel to one another, are secured to the longitudinal bars 24 by welding for example. The crossbars 26 can further be secured to the longitudinal members of the frame 22 by welding for example. Thus, the grill 20 includes slots defined therein.

Each of the handles 30 includes a grip 32 and a connector 50. The grip 32 includes a short rod 34 and a long rod 40. The long rod 40 includes an arched member 42 that extends between two rectilinear members 44 that extend parallel to each other. Each of the rectilinear members 44 includes a flat end 46. The short 34 is secured to the rectilinear members 44 of the long rod 40 by welding for example.

The connector 50 includes a saddle 60 that extends between two plates 52 and 54. The plate 54 extends in a horizontal plane lower than another horizontal plane in which the plate 52 extends. The saddle 60 includes a top 64, two panels 62 and two fins 66. The first panel 62 extends to the first plate 52 from the top 64. The second panel 62 extends to the second plate 54 from the top 64. Both of the fins 66 extend from the first or second panel 62 of the saddle 60 to reduce the gap between the panels 62.

The saddle 60 may further include reinforcement portions 68. The reinforcement portions 68 may be concave-convex portions. At least one of the reinforcement portions 68 is formed at the place where the first plate 52 joins the first panel 62 of the saddle 60. At least one of the reinforcement portions 68 is formed at the place where the first panel 62 of the saddle 60 joins the top 64. At least one of the reinforcement portions 68 is formed at the place where the top 64 of the saddle 60 joins the second panel 62. At least one of the reinforcement portions 68 is formed at the place where the second panel 62 of the saddle 60 joins the second plate 54.

Referring to FIG. 4, the plate 52 is secured to the flat portion 21 of a corresponding one of the longitudinal members of the grill 20 by welding, rivets or screws for example. The plate 54 is secured to the flat ends 46 of the rectilinear members 44 of the long rod 40.

The grill assembly is supported on the bowl 12. The saddle 60 of the connector 50 of each of the handles 30 is placed on the edge of the bowl 12. Preferably, the fins 66 of the saddle 60 of the connector 50 of each of the handles 30 are placed against a wall of the bowl 12. Thus, the grill assembly cannot be moved relative to the bowl 12 as the cover 14 is placed on the grill assembly and the bowl 12. The second plate 54 of the connector 50 of each of the handles 30 is placed lower than an edge of the cover 14 when the top 64 of the saddle 60 is placed on an upper edge of the bowl 12. Thus, the closing of the bowl 12 by the cover 14 is not interfered with by the second plate 54 of the connector 50 of each of the handles 30.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A grill assembly including a grill and at least one handle including a grip and a connector including a first plate connected to the grill, a second plate connected to the grip, and a saddle adapted for placement on an edge of a bowl of a barbecue apparatus, wherein the saddle includes a top and first and second panels respectively extending to the first and second plate from the top, wherein the second plate extends below an edge of a cover laid on the bowl when the top is placed on the edge of the bowl.

2. The grill assembly according to claim 1, wherein the grip includes a long rod including two rectilinear members connected to the second plate and an arched member extending between the rectilinear members.

3. The grill assembly according to claim 2, wherein the grip includes a short rod connected to the rectilinear members of the long rod.

4. The grill assembly according to claim 1, wherein the connector includes at least one fin extending toward one of the first and second panels from the other panel.

5. The grill assembly according to claim 4, wherein the connector includes reinforcement portions at places where the first and second plates, the top and the first and second panels meet one another.

6. The grill assembly according to claim 5, wherein the reinforcement portions are concave-convex portions formed on the connector.

7. The grill assembly according to claim 2, wherein each of the rectilinear members of the long rod includes a flat end to provide an adequate area for contact with the second plate.

8. The grill assembly according to claim 1, wherein the grill includes a frame including at least one flat portion to provide an adequate area for contact with the first plate.
